(19) United States
(12) Patent Application Publication
(10) Pub. No.: US 2026/0217239 A1
(43) Pub. Date: Jul. 30, 2026

(54) WHEEL SLIP CONTROLS AND RESPONSE TO TIRE PRESSURE

(71) Applicant: Ford Global Technologies, LLC, Dearborn, MI (US)

(72) Inventors: Keith WESTON, Canton, MI (US); Matthew JOHNSON, Toledo, OH (US); Cody FACKENDER, Jackson, MI (US)

(21) Appl. No.: 19/040,286

(22) Filed: Jan. 29, 2025

(51) Int. Cl. B60W 30/02; B60W 10/20

(52) U.S. Cl. CPC B60W 30/02; B60W 10/20; B60W 2520/14; B60W 2520/28; B60W 2530/20; B60W 2552/40; B60W 2720/14; B60W 2720/30

(57) ABSTRACT

A control system may include a wheel assembly including a tire operably coupled to the vehicle, a sensor suite operably coupled to the wheel assembly, and a controller configured to receive first data from the sensor suite. The controller may be configured to run a stability control process to monitor wheel slip of the wheel assembly. The stability control process may further include determining and classifying a vehicle stability state based on the first data, adjusting a vehicle traction parameter to increase vehicle stability responsive to the controller classifying the vehicle stability state as a first state in which a likelihood of wheel slip occurrence is increased, and ceasing adjusting the vehicle traction parameter responsive to the first data indicating an exit parameter to the stability control process. The exit parameter may indicate further adjusting of the vehicle traction parameter to have reduced influence on the likelihood of wheel slip occurrence.

### TECHNICAL FIELD

Example embodiments generally relate to the operation of a vehicle's control system and, more particularly, relate to a control system for determining a response to tire pressure to increase vehicle stability.

### BACKGROUND

Tire pressure affects multiple vehicle parameters, such wheel speed, vehicle traction, and other stability-centric vehicle parameters. Being external components and a routine maintenance item, wheel assemblies can experience changes in tire pressure over time. Due to the importance of tire pressure for vehicle performance, it would be useful to be able to detect situations where tire pressure is different from desired pressure and accordingly adjust vehicle systems to ensure vehicle performance.

Numerous vehicle control systems may affect the wheel assemblies of a vehicle, such as anti-lock braking systems, autonomous/assisted driving systems, stability control systems, and drive torque systems. Thus, it may be desirable to be able to modify the adjustments made by the various vehicle control systems to account for tire pressure.

### BRIEF SUMMARY OF SOME EXAMPLES

In accordance with an example embodiment, a control system of a vehicle may be provided. The control system may include a wheel assembly including a tire operably coupled to the vehicle, a sensor suite operably coupled to the wheel assembly, and a controller configured to receive first data from the sensor suite. The controller may be configured to run a stability control process to monitor wheel slip of the wheel assembly. The stability control process may further include determining and classifying a vehicle stability state based on the first data, adjusting a vehicle traction parameter to increase vehicle stability responsive to the controller classifying the vehicle stability state as a first state in which a likelihood of wheel slip occurrence is increased, and ceasing adjusting the vehicle traction parameter responsive to the first data indicating an exit parameter to the stability control process. The exit parameter may indicate further adjusting of the vehicle traction parameter to have reduced influence on the likelihood of wheel slip occurrence.

In another example embodiment, a method for a stability control process to monitor wheel slip of a wheel assembly of a vehicle may be provided. The method may include determining and classifying a vehicle stability state based on first data from a sensor suite operably coupled to the wheel assembly, adjusting a vehicle traction parameter to increase vehicle stability responsive to classifying the vehicle stability state as a first state in which a likelihood of wheel slip occurrence is increased, and ceasing adjusting the vehicle traction parameter responsive to the first data indicating an exit parameter to the stability control process. The exit parameter may indicate further adjusting of the vehicle traction parameter to have reduced influence on the likelihood of wheel slip occurrence.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a block diagram of a vehicle control system in accordance with an example embodiment;

FIG. 2 depicts a flow chart of an algorithm for a stability control system in accordance with an example embodiment;

FIG. 3 illustrates a flow chart for adjusting vehicle traction parameters using vehicle control subsystems in accordance with an example embodiment;

FIG. 4 depicts a flow chart for adjusting vehicle traction parameters using an anti-lock braking system (ABS) in accordance with an example embodiment;

FIG. 5 illustrates a decision chart for determining if an exit parameter has been met in accordance with an example embodiment; and

FIG. 6 illustrates a block diagram of a method in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

Additionally, as used herein, terminology such as “about,” “approximately” and “substantially,” when used to refer to variability of parameters, should be understood to be definite approximations that account for variations in measurements that cannot be, or as one of skill in the art would appreciate, normally are not, measured precisely. Thus, for example, a parameter that is “about,” “approximately” or “substantially” a given value or a given characteristic should be understood to be sufficiently close to the given value or given characteristic such that performance of the object or product to which the parameter applies, from the perspective of one with ordinary skill in the art, is the same as though the object or product had precisely the given value or characteristic.

Some example embodiments described herein may address the issues described above. In this regard, for example, some embodiments may provide a control system with additional functionality and versatility. Some embodiments may provide for the control system to account for variations in tire pressure. As a result, the control system may maintain vehicle stability responsive to variations in tire pressure.

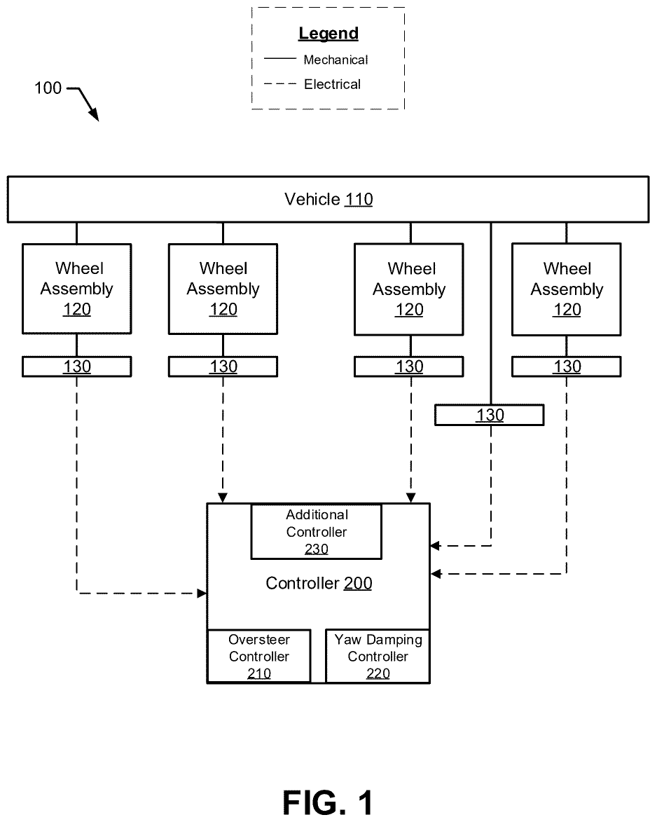

FIG. 1 illustrates a block diagram of a control system according to an example embodiment. The components of the control system 100 may be incorporated into a vehicle 110 (e.g., may be operably coupled to a chassis of the vehicle 110, various components of the vehicle 110 and/or electronic control systems of the vehicle 110). In some cases, the chassis may include or be defined by a frame. The frame may additionally be formed of one or more cast, riveted, or welded metal subframes or may be a unibody construction. Of note, although the components of FIG. 1 may be operably coupled to the vehicle 110 and to each other, it should be appreciated that such connection may be either direct or indirect. Moreover, some of the components of the control system 100 may be connected to the vehicle 110 via intermediate connections to other components either of the chassis or of other electronic and/or mechanical systems or components.

The control system 100 may include a wheel assembly 120. In some cases, the vehicle 110 may include multiple instances of the wheel assembly 120. The wheel assembly 120 may include a tire, a rim, and/or other wheel assembly components to assist in operably coupling the wheel assembly 120 to the vehicle 110. The other vehicle components may include but are not limited to suspension assembly components (e.g. knuckle, control arm, suspension damper, etc.), brake assembly components (e.g. brake rotor, brake pads, brake caliper, etc.) and drive assembly components (e.g. driveshaft, differential, axle, etc.).

In an example embodiment, a sensor suite 130 may be operably coupled to the wheel assembly 120. The sensor suite 130 may include any number of different sensor types depending on the vehicle type and vehicle model. In some cases, the sensor suite 130 may include but is not limited to tire pressure sensors, wheel speed sensors, torque sensors, and environment sensors (e.g., temperature sensors). In some cases, if the vehicle 110 includes multiple instances of the wheel assembly 120, each wheel assembly 120 may be operably coupled to and may include corresponding sensors of the sensor suite 130. For example, each wheel assembly 120 may include its own, respective tire pressure sensor and wheel speed sensor. However, in an example embodiment, the vehicle 110 itself may only include one instance of the specific types of the environment sensors (e.g. one temperature sensor).

Depending on the vehicle type and vehicle model, the number of instances of the specific sensors, as well as the type of sensors, included within the sensor suite 130 may vary. For example, if the vehicle 110 is capable of autonomous operation, a different sensor suite may be required compared to a non-autonomous capable vehicle. In another example, an electric vehicle may require a different sensor suite compared to a gas powered vehicle.

Additionally, the control system 100 may further include a controller 200. While the controller 200 may have many functions, one such function of the controller 200 may be monitoring the status of other components of the vehicle 110. The components that the controller 200 may monitor the status of may be included in, or not included in, the control system 100. In this regard, the controller 200 may be responsible for monitoring components of the vehicle 110 via the sensor suite 130. In an example embodiment, the controller 200 may receive information that may be used to determine the status of various components, subassemblies, or subsystems of the vehicle 110 via the sensor suite 130. For example, the controller 200 may determine and classify a vehicle stability state utilizing the data received, and in some cases also stored, from the sensor suite 130. The sensor suite 130 may be operably coupled to the controller 200 (and/or the components or subassemblies) via mechanical and/or electrical connections. In some cases, the electrical connections may be wireless connections that transmit the data from the sensor suite wirelessly to the controller 200 (e.g. CAN (Controller Area Network) communication channel). In an example embodiment, the controller 200 may include processing circuitry.

The processing circuitry may be configured to provide electronic control inputs to one or more functional units of the control system 100 and to process data received at or generated by the one or more functional units of the control system 100. Thus, the processing circuitry may be configured to perform data processing, control function execution and/or other processing and management services according to an example embodiment. In some embodiments, the processing circuitry may be embodied as a chip or chip set. In other words, the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry may include one or more instances of a processor and memory that may be in communication with or otherwise control other components or modules that interface with the processing circuitry. As such, the processing circuitry may be embodied as a circuit chip (e.g., an integrated circuit chip) configured (e.g., with hardware, software or a combination of hardware and software) to perform operations described herein. In some embodiments, the processing circuitry may be embodied as a portion of an onboard computer housed in the housing to control operation of the control system 100.

In some cases, the controller 200 may include one or more different types of controllers that are specifically responsible for distinct operations of the controller 200. In an example embodiment, the controller 200 may include an oversteer controller 210 and a yaw damping controller 220. The oversteer controller 210 may be configured to detect and determine oversteering of the vehicle 110 and identify an appropriate vehicle parameter to adjust, to limit or to decrease oversteering likelihood. In some cases, the yaw damping controller 220 may be configured to monitor and control the yaw moment (tendency of the vehicle 110 to turn around its vertical axis) via the appropriate vehicle parameters. The oversteer controller 210 and the yaw damping controller 220 may not be the only controller types integrated with the controller 200. In an example embodiment, additional controllers 230 may be included based on vehicle type and vehicle model. For example, the additional controllers 230 may include specific controllers for other vehicle control subsystems (ABS, traction control system (TCS), etc.). The oversteer controller 210, the yaw damping controller 220, and the additional controllers 230 may be separate controllers or may be separate modules within the controller 200.

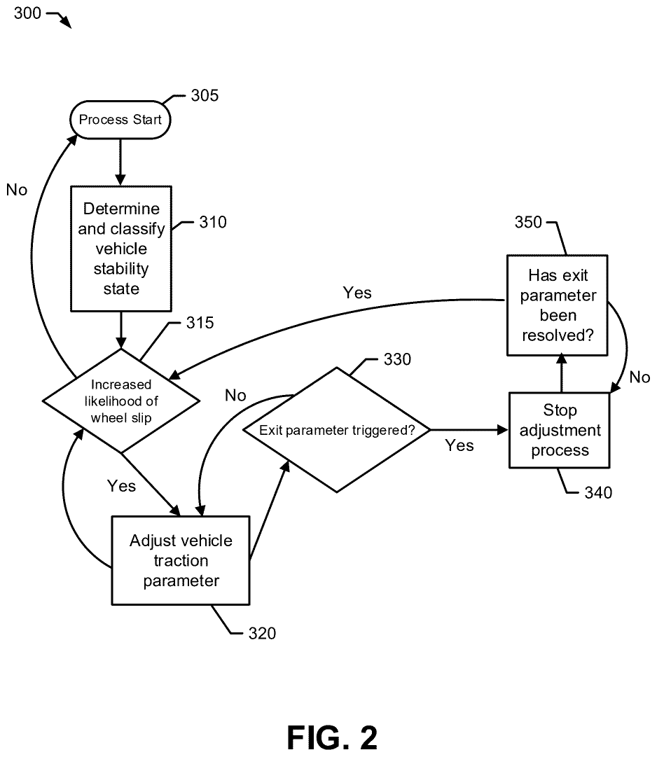

FIG. 2 illustrates a flow chart for an algorithm for stability control system of a vehicle. The algorithm 300 may be run by the controller 200. The algorithm 300 may begin with determining and classifying a vehicle stability state at operation 310 responsive to the initial triggering of the algorithm 300 by the stability control system of the vehicle 110 at operation 305. The controller 200 may initiate the algorithm 300 at predetermined time intervals (e.g. every 5 seconds) or responsive to certain vehicle events. The vehicle events may include, but are not limited to, a change in the environment surrounding the vehicle 110, a change in vehicle mode (e.g., different gear, different driving mode (e.g., sport mode, city mode, autonomous operation), hybrid activation, etc.), change in vehicle speed, etc. The vehicle events may be determined via the data received from the sensor suite 130, as well as other information received internally from other vehicle systems and sensors or externally from external databases or external services (e.g., weather information service) in communication with the controller 200.

In some cases, determining and classifying a vehicle stability state at operation 310 may include the determining if the vehicle 110 is in a first state in which the controller 200 would recommend intervention or a second state in which the controller 200 would not recommend intervention. In an example embodiment, the controller 200 may determine the first state and the second state based on if the vehicle 110 experiences an increased likelihood of wheel slip compared to typical likelihood of wheel slip at operation 315. The typical likelihood of wheel slip may be the likelihood of wheel slip during clear environment conditions and fully operational vehicle control systems and subsystems. In some cases, wheel slip may include lateral and/or longitudinal tire-ground slip or potential tire debeading. In an example embodiment, if the vehicle 110 has an increased likelihood of wheel slip, the controller 200 may classify the vehicle 110 as being in the first state of recommended intervention, and if the vehicle does not have an increased likelihood of wheel slip, the controller 200 may classify the vehicle 110 as being in the second state of no recommended intervention.

In some cases, the controller 200 may further classify an intervention level within the first state as high intervention recommendation or low intervention recommendation dependent on an amount of increase in the likelihood of wheel slip compared to the typical likelihood of wheel slip. The controller 200 may determine the likelihood of wheel slip (and thus classify the intervention level) utilizing data from the sensor suite 130, such as but not limited to, the environment data around the vehicle, vehicle actions (e.g. turning, straightaway, etc.), and vehicle modes. In some cases, high intervention recommendation may correspond to when the likelihood of wheel slip increases above an upper intervention threshold and low intervention recommendation may correspond to when the likelihood of wheel slip increases above a low intervention threshold but below the high intervention threshold. Responsive the vehicle stability state being classified as the second state at operation 315, the algorithm 300 may return to the process start at operation 305 to await the next trigger/initiation (e.g. after a predetermined time period, standby period to await next trigger while continuously running) to determine and classify the vehicle stability state again. Responsive to the vehicle stability state being classified as the first state at operation 315, the algorithm 300 may continue to adjust a vehicle traction parameter at operation 320.

In some cases, adjusting a vehicle traction parameter at operation 320 may include adjusting multiple instances of a vehicle traction parameter. A vehicle traction parameter may include adjusting a parameter of a control subsystem of the vehicle 110 that affects wheel slip. In an example embodiment, the control subsystem may include and is not limited to an anti-lock brake system (ABS), a traction control system (TCS), and other electronic stability control systems (ESC). For example, if the controller 200 determines the ABS needs adjustment, the vehicle traction parameter may include brake or propulsion torque, and if the controller 200 determines the TCS needs adjustment, the vehicle traction parameter may include wheel speed. In some cases, the ESC may adjust or activate other control subsystems responsive to the controller 200 determining an adjustment is needed. For example, the ESC may adjust the settings of the ABS and TCS to adjust brake or propulsion torque and wheel speed respectively responsive the controller 200 classifying the vehicle stability state as the first state.

Responsive to adjusting the vehicle traction parameter at operation 320, the algorithm 300 may return to operation 315 to determine if the increased likelihood of wheel slip is still present. Thus, if the adjustment was successful in reducing likelihood of wheel slip, the algorithm 300 may proceed back to the process start at operation 305. However, if the adjustment was not successful and did not reduce the likelihood of wheel slip a sufficient amount (e.g. below the low intervention threshold), the algorithm 300 may continue to operation 320 to adjust vehicle traction parameters once again. In some cases, the cycle between operations 315 and 320 may continue until the increased likelihood of wheel slip is decreased back to typical likelihood of wheel slip (e.g. below the low intervention threshold).

During the adjustment of the vehicle traction parameter at operation 320, an exit parameter may be monitored by the controller 200 at operation 330. The exit parameter may indicate that further adjustment of the vehicle traction parameter has a reduced influence or effect on reducing the likelihood of wheel slip. In an example embodiment, the exit parameter may include a coefficient of friction of a driving surface (μ) of the vehicle 110, wheel speed, and an intervention level. The controller 200 may base the exit parameter on data, including but not limited to, the coefficient of friction of a driving surface, the wheel speed, and a yaw lag time. Yaw lag time may be defined as a delay that occurs between the turning of the steering wheel and the vehicle 110 actually begins to turn. The controller 200 may monitor the exit parameter utilizing data from the sensor suite 130. In some cases, the controller 200 may monitor multiple different types of the exit parameter simultaneously. The specific types of the exit parameter monitored by the controller 200 may depend on vehicle type and vehicle model.

In some cases, the monitoring of the exit parameter at operation 330 may include monitoring if a threshold or limit of the exit parameter is triggered upon which the further adjustment of the vehicle traction parameter has a reduced influence or effect on reducing the likelihood of wheel slip. The threshold, limit, comparison, and/or range of the exit parameter may depend on a look up table based on the condition/status of the vehicle 110 and the control systems/subsystems. For example, if the exit parameter is the coefficient of friction of the driving surface, the exit parameter may trigger responsive to the coefficient of friction of the driving surface being below a friction threshold, such as μ<0.2 (0.2 is a typical coefficient of friction for an icy road). In another example, if the exit parameter is wheel speed, the exit parameter may trigger responsive to the wheel speed of one wheel assembly deviating from the wheel speed of another wheel assembly by more than certain percentage (e.g. deviating by 2%).

In an example embodiment, responsive to triggering the exit parameter at operation 330, the algorithm 300 may stop or cease the adjusting of the vehicle traction parameter (operation 320) at operation 340. In addition to ceasing the adjusting of the vehicle traction parameter, responsive to triggering of the exit parameter, the controller 200 may cease to adjust or even cease/stop other algorithms and processes within the vehicle 110. For example, the controller 200 may cease to adjust or cease/stop operation of a cruise control algorithm, an autonomous driving mode, or blind spot monitoring responsive to triggering of the exit parameter. Responsive to stopping the adjusting of the vehicle traction parameter, the controller 200 may monitor the exit parameter to determine if the exit parameter has been resolved. In an example embodiment, resolving the exit parameter may be the exit parameter being above a specific threshold or within an acceptable range for a certain time period. If the exit parameter is not resolved, the adjusting of the vehicle traction parameter may continue to be stopped. Responsive to the exit parameter being resolved, the algorithm 300 may return to determining if the vehicle is experiencing an increased likelihood of wheel slip at operation 315.

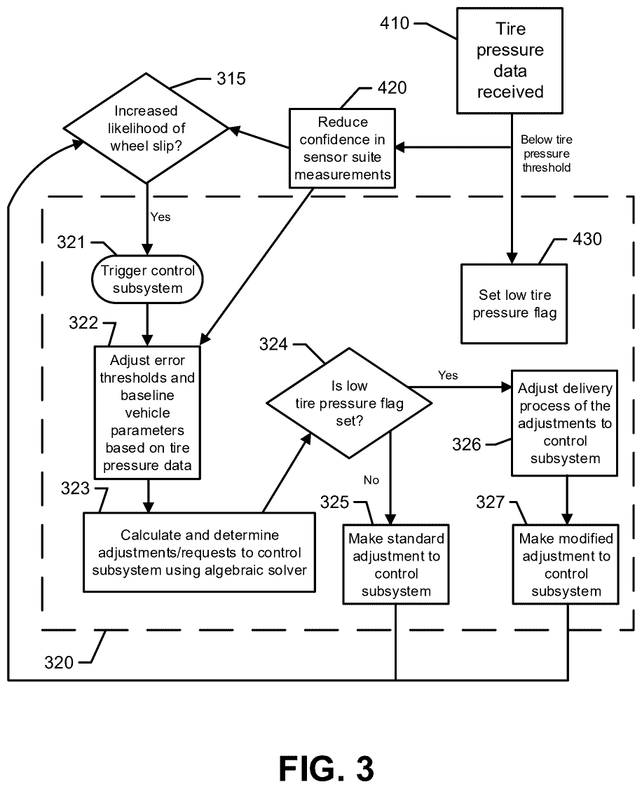

FIG. 3 depicts a flow chart showing further details regarding the adjusting of the vehicle traction parameter for general control subsystems according to an example embodiment. In some cases, upon determining there is an increased likelihood of wheel slip at operation 315, the adjusting of the vehicle traction parameter of operation 320 may begin with triggering a control subsystem (ABS, TCS, etc.) at operation 321. The control subsystems may include their own, respective control activation thresholds that determine the triggering of control subsystem for adjustments (e.g. control activation thresholds may be varying levels of increased likelihood of wheel slip for each control subsystem). In some cases, the controller 200 may run multiple control subsystems simultaneously depending on the intervention level and specific increase in the likelihood of wheel slip. For example, if the likelihood of wheel slip has increased beyond a specific high intervention threshold, the controller 200 may determine that the vehicle 110 may need increased intervention and that multiple control subsystems may thus need adjustment.

In some cases, the algorithm 300 may be modified responsive to receiving additional data from the sensor suit 130 (e.g. modify control activation thresholds that trigger control subsystem adjustment). For example, as seen in FIG. 3, tire pressure data may be received from the sensor suit 130 by the controller 200 at operation 410. Operation 410 may occur separately and concurrently with the other operations of the algorithm 300. Responsive to receiving the tire pressure data, the controller 200 may determine if the tire pressure data is above or below a tire pressure threshold. The specific tire pressure threshold may depend on the tire type, the tire model, the vehicle type, and the vehicle model. The tire pressure threshold may be determined via a lookup table. In some cases, the controller 200 may include multiple instances of the tire pressure threshold, such as but not limited to, a low tire pressure threshold (underinflated) and high tire pressure threshold (overinflated).

Responsive to the tire pressure data being below a tire pressure threshold, the controller 200 may set a tire pressure flag within the algorithm 300 at operation 430. The tire pressure flag may determine and modify the adjustments made by the control subsystem at operation 320.

In an example embodiment, responsive to the tire pressure data being below a tire pressure threshold or outside a desired tire pressure range, the controller 200 may reduce a confidence level in measurements of the sensor suite 130 used throughout the algorithm 300, as well as other algorithms or programs that use data from the sensor suit 130, at operation 420. For example, in some cases, the controller 200 may apply the reduced confidence level in sensor suite measurements to the determination of whether an increased likelihood of wheel slip is present. Responsive to the reduced confidence level in the sensor suite measurement, the controller 200 may modify the high intervention threshold and the low intervention threshold regarding the likelihood of wheel slip. For example, the controller 200 may decrease the low intervention threshold to apply adjustments to the vehicle traction parameters at lower increased likelihoods of wheel slips to account for the lower confidence levels in the measurements of the sensor suite 130. In some cases, the controller 200 may increase the high intervention threshold to account for the lower confidence levels in the measurements of the sensor suite 130 to limit false activation of high intervention.

The reduction of the confidence level in measurements of the sensor suite 130 at operation 420 may also result in the controller 200 adjusting error thresholds and baseline vehicle parameters values based on tire pressure data at operation 322. The controller 200 may adjust the error thresholds and baseline vehicle parameters values in operation 322 in addition to previous adjustments made to other operations within the algorithm 300. The adjustments to error thresholds and baseline vehicle parameters values may include tightening/narrowing stability thresholds for vehicle 110. For example, responsive to low tire pressure and the controller 200 requesting intervention after operation 315, the controller 200 may reduce the yaw rate error allowed (xdeg/s), the lateral slip targets, and the longitudinal slip targets for the wheel assembly 120. The tightening/narrowing of stability thresholds may enable quicker intervention to increased likelihood of wheel slip or quicker determination of what adjustments the vehicle 110 needs.

In some cases, the adjustment error thresholds and baseline vehicle parameters values in operation 322 may include tightening/narrowing control deadbands. The control deadbands may include, but are not limited to, controls for the oversteer controller and the yaw rate controller. Tightening/narrowing the control deadbands may result in quicker adjustments as the smaller deadband would decrease the range in which the oversteer controller 210 and the yaw damping controller 220 would not respond to an input.

Responsive to the adjusting of error thresholds and baseline vehicle parameters values based on tire pressure data at operation 322, the controller 200 may calculate and determine specific adjustments to the control subsystem based on the operation 315 and operation 322 at operation 323. The controller 200 may utilize an algebraic solver and/or lookup tables to determine the needed adjustments for the control subsystem.

Responsive to the calculation and determination of the adjustments for the control subsystem, the controller 200 may check if a low tire pressure flag was previously set (operation 430) prior to the controller 200/control subsystem making the adjustments at operation 324. If the low tire pressure flag is not set, the controller 200 may instruct the control subsystem to perform a standard adjustment to the control subsystem at operation 325. In some cases, the standard adjustment may be the calculated and determined specific adjustments to the control subsystem of operation 323 delivered at a typical adjustment delivery rate for the control subsystem (e.g. typical application rate of brake or propulsion torque).

If the low tire pressure flag is set at operation 324, the controller 200 may instruct the control subsystem to modify a delivery process of the adjustment at operation 326. In an example embodiment, the delivery process may be the rate at which the adjustment is applied and/or specific cutoffs to stop providing the adjustment. The delivery process may be adjusted responsive to the low tire pressure to prevent providing an adjustment that the wheel assembly 120 cannot receive and still maintain its current stability given its current tire pressure. For example, at low tire pressure, the wheel assembly 120 may have a lower wheel speed and the tire may have a lower grip to maintain operable coupling to the wheel assembly 120. Thus, in some cases, a standard adjustment and delivery may increase the likelihood of the tire slipping radially around the wheel and/or potential de-beading of the wheel assembly 120.

Responsive to modifying the delivery process of the adjustment at operation 326, the controller 200 may make the modified adjustment to the control subsystem at operation 327. In some cases, only the delivery process of the adjustments to the control subsystem may be modified responsive to the low tire pressure flag being set. The controller 200 may already account for the low tire pressure values in the initial calculation and determination of the adjustment to the control subsystem due to the adjustment error thresholds and baseline vehicle parameters based on the tire pressure data at operation 322. In an example embodiment, further modification of the specific adjustment value may also occur at operation 326 responsive to determining the low tire pressure flag is set.

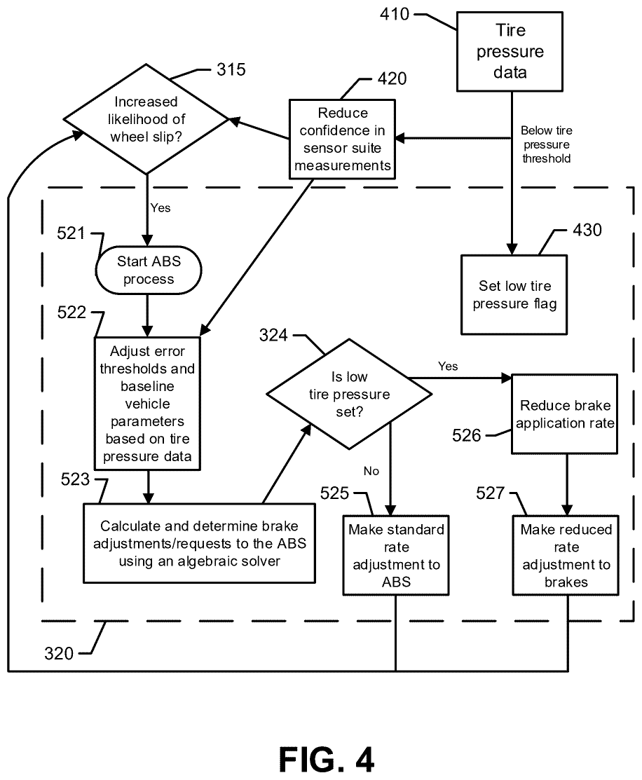

FIG. 4 depicts a flow chart showing further details regarding the adjusting of the vehicle traction parameter for an ABS according to an example embodiment. In an example embodiment, the controller 200 may determine an ABS may need to be adjusted responsive increased likelihood of wheel slip at operation 315. The controller 200 may initially start the ABS process at operation 521. In some cases, starting the ABS process may include opening communication channels between the ABS and the controller 200. Responsive to starting the ABS process at operation 521, the controller 200 may adjust error thresholds and baseline vehicle parameters based on tire pressure data at operation 522. The adjustment at operation 522 may include the low tire pressure adjustments based on the tire pressure data being below a tire pressure threshold and the corresponding reduction in confidence in sensor suite measurements at operations 410 and 420.

Responsive to the adjustments in error thresholds and baseline vehicle parameters at operation 522, the controller 200 may calculate and determine brake adjustments/requests to the ABS using an algebraic solver at operation 523. For example, the algebraic solver may re-distribute brake or propulsion torque to other tires of the vehicle 110 from a low-pressure tire (e.g. increase left rear brake ramp rate while limiting left front brake ramp rate responsive to left front tire being at low pressure). Operation 523 may further utilize lookup tables and algorithms to assist in adjustment calculations and determinations. Responsive to the adjustment calculation and determination at operation 523, the controller 200 may check if a low tire pressure flag is set at operation 324. Responsive to the low tire pressure flag not being set at operation 324, the controller 200 may instruct the ABS to make the adjustment and submit a request to a brake actuator to provide an amount of brake or propulsion torque at the standard rate according to the adjustment at operation 525. Responsive to the low tire pressure flag being set at operation 324, the controller 200 may instruct the ABS to make the adjustment to provide an amount of brake or propulsion torque (or propulsive and retarding torque) at a reduced rate compared to the standard rate according to the adjustment at operation 526. Responsive to operation 526, a request may be sent to a brake actuator to apply the determined amount of brake or propulsion torque and/or torques from operation 523 at a reduced rate at operation 527.

While FIG. 4 depicts an example embodiment in which the control subsystem is an ABS, the controller 200 may provide similar adjustment processes for other control subsystems, such as but not limited to a TCS and other specific stability control systems. For example, the controller 200 may modify the adjustment of the vehicle traction parameter of yaw lag time for the ESC. The controller 200 may modify the cornering compliance parameters to adjust the yaw lag time following a similar methodology as previously presented.

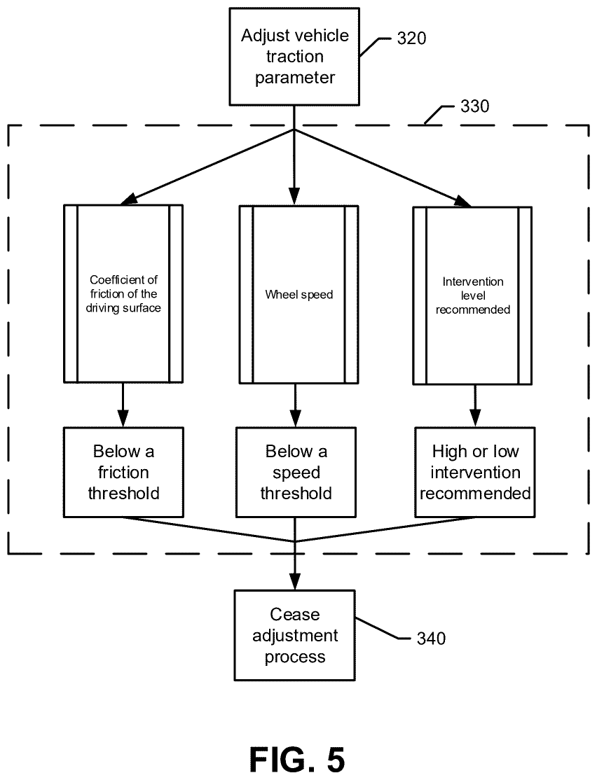

FIG. 5 further illustrates a decision chart for determining if an exit parameter has triggered in accordance with an example embodiment. In some cases, the exit parameter may include, but is not limited to, the coefficient of friction of the driving surface, wheel speed, and/or intervention level needed. Each exit parameter may include a different trigger for indicating the adjustment process has reduced influence on the decreasing the likelihood of wheel slip. For example, the trigger if the exit parameter is the coefficient of friction of the driving surface may be the coefficient of friction being below a friction threshold. The friction threshold may depend on the vehicle type, vehicle model, environmental conditions, tire pressure, and/or other sensor suite measurements. In an example embodiment, if tire pressure is low (e.g. below tire pressure threshold), the controller 200 may increase the friction threshold to increase the ease of triggering the exit parameter as adjustments on a low pressure tire may have a reduced effect compared to the same adjustments on a properly inflated tire.

In some cases, the trigger if the exit parameter is wheel speed may be the wheel speed being below a speed threshold. Similar to the coefficient of friction example, the speed threshold may depend on the vehicle type, vehicle model, environmental conditions, tire pressure, and/or other sensor suite measurements. In an example embodiment, the trigger if the exit parameter is intervention level may be intervention level relative to the high intervention threshold and low intervention threshold previously used in operation 315. In some cases, the controller 200 may continually monitor and adjust the high intervention threshold and low intervention threshold throughout running of the algorithm 300. Once again, similar to the coefficient of friction and the wheel speed examples, the high intervention threshold and/or the low intervention threshold may depend on the vehicle type, vehicle model, environmental conditions, tire pressure, and/or other sensor suite measurements. Responsive to triggering of the exit parameter, the controller 200 may cease the adjustment process of operation 320 at operation 340.

In an example embodiment, the controller 200 may monitor for high tire pressure or over-inflation in addition to low tire pressure. The controller 200 may monitor a high tire pressure threshold and set a separate high tire pressure flag if the tire pressure exceeds the high tire pressure threshold. The controller 200 may perform similar adjustments to the algorithm 300 responsive to high tire pressure, such as but not limited to reducing confidence in sensor suite measurements (operation 420) and the adjusting various thresholds and vehicle parameters (operation 322, 323, 522, and 523). In some cases, depending on the mode of the vehicle 110 (e.g. off-road mode), the thresholds (e.g. tightening/narrowing stability thresholds) and tuning of the algorithm 300 and control subsystems may change. For example, in an off-road mode, an acceptable range of the likelihood of wheel slip may be increased compared to typical driving modes (e.g. cruise control, sport mode, and/or other on-road driving modes). In an another example embodiment, if the vehicle 110 is in an off-road mode and experiences normal or high tire pressure, the algorithm 300 may limit the acceptable range of the likelihood of wheel slip to help keep the tires from digging themselves into holes and getting the vehicle stuck.

In some cases, the controller 200 may monitor a specific axle of the vehicle instead of, or along with, monitoring individual instances of the wheel assembly 120. In an example embodiment, the controller 200 may monitor specific corners of the vehicle 110 and modify adjustments to redistribute forces/adjust parameters based on specific corner monitoring. In some cases, adjustments and modifications may include modifying a bicycle model for the vehicle 110 based on tire pressure. The modifications to the bicycle model may utilize look up tables for the specific vehicle model or vehicle type.

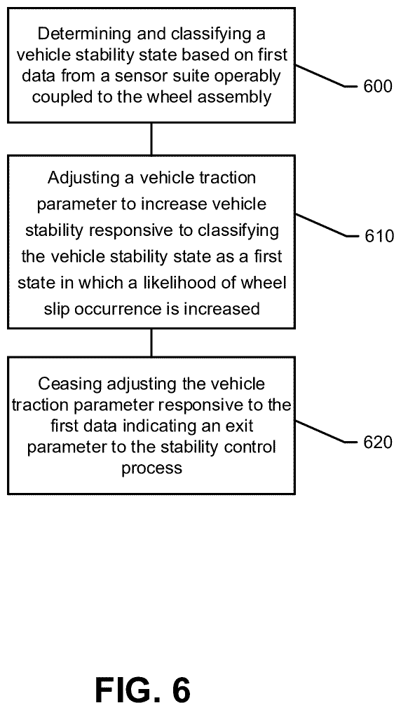

FIG. 6 illustrates a block diagram of a method for a stability control process to monitor wheel slip of a wheel assembly of a vehicle in accordance with an example embodiment. The method may include determining and classifying a vehicle stability state based on first data from a sensor suite operably coupled to the wheel assembly at operation 600. The method may further include adjusting a vehicle traction parameter to increase vehicle stability responsive to classifying the vehicle stability state as a first state in which a likelihood of wheel slip occurrence is increased at operation 610. The method also may finally include ceasing adjusting the vehicle traction parameter responsive to the first data indicating an exit parameter to the stability control process at operation 620.

A control system of a vehicle may therefore be provided. The control system may include a wheel assembly including a tire operably coupled to the vehicle, a sensor suite operably coupled to the wheel assembly, and a controller configured to receive first data from the sensor suite. The controller may be configured to run a stability control process to monitor wheel slip of the wheel assembly. The stability control process may further include determining and classifying a vehicle stability state based on the first data, adjusting a vehicle traction parameter to increase vehicle stability responsive to the controller classifying the vehicle stability state as a first state in which a likelihood of wheel slip occurrence is increased, and ceasing adjusting the vehicle traction parameter responsive to the first data indicating an exit parameter to the stability control process. The exit parameter may indicate further adjusting of the vehicle traction parameter to have reduced influence on the likelihood of wheel slip occurrence.

The control system of a vehicle of some embodiments may include additional features, modifications, augmentations and/or the like to achieve further objectives or enhance performance of the suspension assembly. The additional features, modifications, augmentations and/or the like may be added in any combination with each other. Below is a list of various additional features, modifications, and augmentations that can each be added individually or in any combination with each other. For example, the first data may include coefficient of friction of a driving surface, wheel speed, and yaw lag time. In some cases, the exit parameter may include the coefficient of friction of the driving surface being below a friction threshold. In an example embodiment, the stability control process may further include receiving additional data from the sensor suite, and responsive to receiving the additional data from the first sensor suite, may modify the adjusting of the vehicle traction parameter based on the additional data from a standard adjustment or modifying the classifying of the vehicle stability state based on the additional data from a standard classification. In some cases, the sensor suite may include a tire pressure sensor, and the additional data may include tire pressure. In an example embodiment, responsive to the additional data indicating the tire pressure is below a tire pressure threshold, the modifying of the adjusting of the vehicle traction parameter may include reducing a rate of change of propulsive and retarding torque applied to the wheel assembly compared to the standard adjustment. In some cases, responsive to the additional data indicating the tire pressure is below a tire pressure threshold, the modifying of the adjusting of the vehicle traction parameter may include adjusting yaw lag time by changing cornering compliance parameters based the additional data compared to the standard adjustment. In an example embodiment, responsive to the additional data indicating the tire pressure is below a tire pressure threshold, the modifying of the adjustment of the vehicle traction parameter may include narrowing control deadbands on controls for an oversteer controller and a yaw damping controller compared to the standard adjustment, and the oversteer controller and the yaw damping controller may be integrated with the controller. In some cases, responsive to the additional data indicating the tire pressure is below a tire pressure threshold, the modifying of the adjustment of the vehicle traction parameter may include increasing sensitivity of triggering the exit parameter compared to the standard adjustment. In an example embodiment, increasing sensitivity of triggering the exit parameter may include modifying respective thresholds of each one of the multiple different instances of the exit parameters. In some cases, responsive indicating the tire pressure is below a tire pressure threshold, modifying the classifying of the vehicle stability state may include narrowing stability thresholds that the classifying of the vehicle stability state is based on compared to the standard classification. In an example embodiment, the stability thresholds may include yaw rate error, lateral slip targets, or longitudinal slip targets. In some cases, narrowing the stability thresholds may be based on whether the vehicle is in an on-road mode or an off-road mode. In an example embodiment, the wheel assembly may include two or more tires operably coupled to an axle of the vehicle.

A method for a stability control process to monitor wheel slip of a wheel assembly of a vehicle may be provided. The method may include determining and classifying a vehicle stability state based on first data from a sensor suite operably coupled to the wheel assembly, adjusting a vehicle traction parameter to increase vehicle stability responsive to classifying the vehicle stability state as a first state in which a likelihood of wheel slip occurrence is increased, and ceasing adjusting the vehicle traction parameter responsive to the first data indicating an exit parameter to the stability control process. The exit parameter may indicate further adjusting of the vehicle traction parameter to have reduced influence on the likelihood of wheel slip occurrence.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed:

1. A control system of a vehicle, the control system comprising:
a wheel assembly including a tire operably coupled to the vehicle;
a sensor suite operably coupled to the wheel assembly; and
a controller configured to receive first data from the sensor suite,
wherein the controller is configured to run a stability control process to monitor wheel slip of the wheel assembly, the stability control process further comprising:
determining and classifying a vehicle stability state based on the first data;
adjusting a vehicle traction parameter to increase vehicle stability responsive to the controller classifying the vehicle stability state as a first state in which a likelihood of wheel slip occurrence is increased; and
ceasing adjusting the vehicle traction parameter responsive to the first data indicating an exit parameter to the stability control process,
wherein the exit parameter indicates further adjusting of the vehicle traction parameter to have reduced influence on the likelihood of wheel slip occurrence.

2. The control system of claim 1, wherein the first data includes coefficient of friction of a driving surface, wheel speed, and yaw lag time.

3. The control system of claim 2, wherein the exit parameter includes the coefficient of friction of the driving surface being below a friction threshold.

4. The control system of claim 1, wherein the stability control process further comprises receiving additional data from the sensor suite, and
responsive to receiving the additional data from the first sensor suite, modifying the adjusting of the vehicle traction parameter based on the additional data from a standard adjustment or modifying the classifying of the vehicle stability state based on the additional data from a standard classification.

5. The control system of claim 4, wherein the sensor suite includes a tire pressure sensor, and
wherein the additional data includes tire pressure.

6. The control system of claim 5, wherein responsive to the additional data indicating the tire pressure is below a tire pressure threshold, the modifying of the adjusting of the vehicle traction parameter includes reducing a rate of application of driving or retarding torque applied to the wheel assembly compared to the standard adjustment.

7. The control system of claim 5, wherein responsive to the additional data indicating the tire pressure is below a tire pressure threshold, the modifying of the adjusting of the vehicle traction parameter includes adjusting yaw lag time by changing cornering compliance parameters based on the additional data compared to the standard adjustment.

8. The control system of claim 5, wherein responsive to the additional data indicating the tire pressure is below a tire pressure threshold, the modifying of the adjustment of the vehicle traction parameter includes narrowing control deadbands on controls for an oversteer controller and a yaw damping controller compared to the standard adjustment,
wherein the oversteer controller and the yaw damping controller are integrated with the controller.

9. The control system of claim 5, wherein responsive to the additional data indicating the tire pressure is below a tire pressure threshold, the modifying of the adjustment of the vehicle traction parameter includes increasing sensitivity of triggering the exit parameter compared to the standard adjustment.

10. The control system of claim 9, wherein increasing sensitivity of triggering the exit parameter includes modifying respective thresholds of each one of multiple different instances of the exit parameters.

11. The control system of claim 5, wherein responsive indicating the tire pressure is below a tire pressure threshold, modifying the classifying of the vehicle stability state includes narrowing stability thresholds that the classifying of the vehicle stability state is based on compared to the standard classification.

12. The control system of claim 11, wherein the stability thresholds include yaw rate error, lateral slip targets, or longitudinal slip targets.

13. The control system of claim 11, wherein narrowing the stability thresholds is based on whether the vehicle is in an on-road mode or an off-road mode.

14. The control system of claim 1, wherein the wheel assembly includes two or more tires operably coupled to an axle of the vehicle.

15. A method for a stability control process to monitor wheel slip of a wheel assembly of a vehicle, the method comprising:
determining and classifying a vehicle stability state based on first data from a sensor suite operably coupled to the wheel assembly;
adjusting a vehicle traction parameter to increase vehicle stability responsive to classifying the vehicle stability state as a first state in which a likelihood of wheel slip occurrence is increased; and
ceasing adjusting the vehicle traction parameter responsive to the first data indicating an exit parameter to the stability control process,
wherein the exit parameter indicates further adjusting of the vehicle traction parameter to have reduced influence on the likelihood of wheel slip occurrence.

16. The method of claim 15, wherein the first data includes coefficient of friction of a driving surface, wheel speed, and yaw lag time.

17. The method of claim 16, wherein the exit parameter includes the coefficient of friction of the driving surface being below a friction threshold.

18. The method of claim 15, wherein the stability control process further comprises receiving additional data from the sensor suite, and
responsive to receiving the additional data from the first sensor suite, modifying the adjusting of the vehicle traction parameter based on the additional data from a standard adjustment or modifying the classifying of the vehicle stability state based on the additional data from a standard classification.

19. The method of claim 18, wherein the sensor suite includes a tire pressure sensor to monitor tire pressure of a tire of the wheel assembly, and
wherein the additional data includes tire pressure.

20. The method of claim 19, wherein responsive to the additional data indicating the tire pressure is below a tire pressure threshold, the modifying of the adjusting of the vehicle traction parameter includes reducing a rate of change of propulsive and retarding torque applied to the wheel assembly compared to the standard adjustment.
